(19) United States
(12) Patent Application Publication
(10) Pub. No.: US 2026/0195620 A1
(43) Pub. Date: Jul. 9, 2026

(54) SECURE VERIFICATION OF TRAINED MODELS

(71) Applicant: INTERNATIONAL BUSINESS MACHINES CORPORATION, ARMONK, NY (US)

(72) Inventors: TYLER VEZIO RIMALDI, MAHOPAC, NY (US); MICHAEL E GILDEIN, WAPPINGERS FALLS, NY (US); TABARI ALEXANDER, HYDE PARK, NY (US); MARCEL SCHAAL, FORT MONTGOMERY, NY (US)

(21) Appl. No.: 19/014,574

(22) Filed: Jan. 9, 2025

(51) Int. Cl. G06N 5/045

(52) U.S. Cl. CPC G06N 5/045

(57) ABSTRACT

Secure verification of trained models, including: performing an inference operation on input inference data using a trained model; applying, to verifiable input data, one or more transformations based on an inference path of the trained model during the inference operation, thereby generating transformed verifiable input data; and verifying the trained model based on the transformed verifiable input data.

### BACKGROUND

The present disclosure relates to methods, apparatus, and products for secure verification of trained models.

### SUMMARY

According to embodiments of the present disclosure, various methods, apparatus and products for secure verification of trained models are described herein. In some aspects, secure verification of trained models includes performing an inference operation on input inference data using a trained model; applying, to verifiable input data, one or more transformations based on an inference path of the trained model during the inference operation, thereby generating transformed verifiable input data; and verifying the trained model based on the transformed verifiable input data. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a diagram of an example computing environment for secure verification of trained models according to aspects of the present disclosure.

FIG. 2 sets forth a diagram of an example of parallel inference and model verification for secure verification of trained models in accordance with some embodiments of the present disclosure.

FIG. 3 sets forth a flowchart of an example method of secure verification of trained models in accordance with some embodiments of the present disclosure.

FIG. 4 sets forth a flowchart of another example method of secure verification of trained models in accordance with some embodiments of the present disclosure.

FIG. 5 sets forth a flowchart of another example method of secure verification of trained models in accordance with some embodiments of the present disclosure.

FIG. 6 sets forth a flowchart of another example method of secure verification of trained models in accordance with some embodiments of the present disclosure.

FIG. 7 sets forth a flowchart of another example method of secure verification of trained models in accordance with some embodiments of the present disclosure.

### DETAILED DESCRIPTION

In some aspects, a method may include: performing an inference operation on input inference data using a trained model; applying, to verifiable input data, one or more transformations based on an inference path of the trained model during the inference operation, thereby generating transformed verifiable input data; and verifying the trained model based on the transformed verifiable input data. This provides the technical advantage of model verification by tracing the inference path of a model using verifiable inputs, improving system security and utility.

In some aspects, verifying the trained model based on the transformed verifiable input data comprises: reversing the one or more transformations applied to the transformed verifiable input data thereby generating expected input data; and comparing the expected input data to the verifiable input data. This provides the technical advantage of verifying the input data transformed based on the inference path of the model by reversing the applied transformations, leveraging the variable nature of the applied transformations, improving system security and utility.

In some aspects, applying the one or more transformations comprises applying the one or more transformations in parallel with the inference operation by tracing the inference path of the trained model during the inference operation. This provides the technical advantage of improving overall security of model verification by enforcing parallel execution of inference and transformations, improving system security and utility.

In some aspects, performing the inference operation comprises performing the inference operation using an artificial intelligence unit (AIU). This provides the technical advantage of performing inference operations using specialized and secure hardware, improving overall performance and system utility.

In some aspects, applying the one or more transformations comprises applying the one or more transformations using a trusted hardware unit (THU). This provides the technical advantage of performing transformations using specialized and secure hardware, improving overall performance and system utility.

In some aspects, the method further comprises generating a data structure describing each portion of the inference path and a subset of the one or more transformations applied at each portion of the inference path. This provides the technical advantage of providing additional data that may be used for model and environment verification, improving overall system hardware and utility.

In some aspects, the one or more transformations comprise one or more logical operations.

In some aspects, a computer system may include: a processor set; one or more computer-readable storage media; and program instructions stored on the one or more storage media to cause the processor set to perform operations comprising: performing an inference operation on input inference data using a trained model; applying, to verifiable input data, one or more transformations based on an inference path of the trained model during the inference operation, thereby generating transformed verifiable input data; and verifying the trained model based on the transformed verifiable input data. This provides the technical advantage of model verification by tracing the inference path of a model using verifiable inputs, improving system security and utility.

In some aspects, verifying the trained model based on the transformed verifiable input data comprises: reversing the one or more transformations applied to the transformed verifiable input data thereby generating expected input data; and comparing the expected input data to the verifiable input data. This provides the technical advantage of verifying the input data transformed based on the inference path of the model by reversing the applied transformations, leveraging the variable nature of the applied transformations, improving system security and utility.

In some aspects, applying the one or more transformations comprises applying the one or more transformations in parallel with the inference operation by tracing the inference path of the trained model during the inference operation. This provides the technical advantage of improving overall security of model verification by enforcing parallel execution of inference and transformations, improving system security and utility.

In some aspects, performing the inference operation comprises performing the inference operation using an artificial intelligence unit (AIU). This provides the technical advantage of performing inference operations using specialized and secure hardware, improving overall performance and system utility.

In some aspects, applying the one or more transformations comprises applying the one or more transformations using a trusted hardware unit (THU). This provides the technical advantage of performing transformations using specialized and secure hardware, improving overall performance and system utility.

In some aspects, the operations further comprise generating a data structure describing each portion of the inference path and a subset of the one or more transformations applied at each portion of the inference path. This provides the technical advantage of providing additional data that may be used for model and environment verification, improving overall system hardware and utility.

In some aspects, the one or more transformations comprise one or more logical operations.

In some aspects, a computer program product includes: one or more computer-readable storage media; and program instructions stored on the one or more storage media to perform operations comprising: performing an inference operation on input inference data using a trained model; applying, to verifiable input data, one or more transformations based on an inference path of the trained model during the inference operation, thereby generating transformed verifiable input data; and verifying the trained model based on the transformed verifiable input data. This provides the technical advantage of model verification by tracing the inference path of a model using verifiable inputs, improving system security and utility.

In some aspects, verifying the trained model based on the transformed verifiable input data comprises: reversing the one or more transformations applied to the transformed verifiable input data thereby generating expected input data; and comparing the expected input data to the verifiable input data. This provides the technical advantage of verifying the input data transformed based on the inference path of the model by reversing the applied transformations, leveraging the variable nature of the applied transformations, improving system security and utility.

In some aspects, applying the one or more transformations comprises applying the one or more transformations in parallel with the inference operation by tracing the inference path of the trained model during the inference operation. This provides the technical advantage of improving overall security of model verification by enforcing parallel execution of inference and transformations, improving system security and utility.

In some aspects, performing the inference operation comprises performing the inference operation using an artificial intelligence unit (AIU). This provides the technical advantage of performing inference operations using specialized and secure hardware, improving overall performance and system utility.

In some aspects, applying the one or more transformations comprises applying the one or more transformations using a trusted hardware unit (THU). This provides the technical advantage of performing transformations using specialized and secure hardware, improving overall performance and system utility.

In some aspects, the operations further comprise generating a data structure describing each portion of the inference path and a subset of the one or more transformations applied at each portion of the inference path. This provides the technical advantage of providing additional data that may be used for model and environment verification, improving overall system hardware and utility.

Bring Your Own Model (BYOM) systems allow users to provide their own model for execution in a dedicated machine learning platform. This allows for users to leverage the underlying hardware or execution environment of these machine learning platforms to perform inferences using their own trained models. Though this may provide various performance benefits, a user is effectively relinquishing control of how their models are executed.

Verifying a model ensures that both the executed model and the execution environment used to execute the model are as described and as expected. Current methods of verifying models may use inference comparisons by setting seed values to vet reproducibility. This approach is flawed as it can be maliciously reproduced in a similar model. Other methods may use check-sums of the model deployment or some other physical check. This may be insufficient to verify the model during inference.

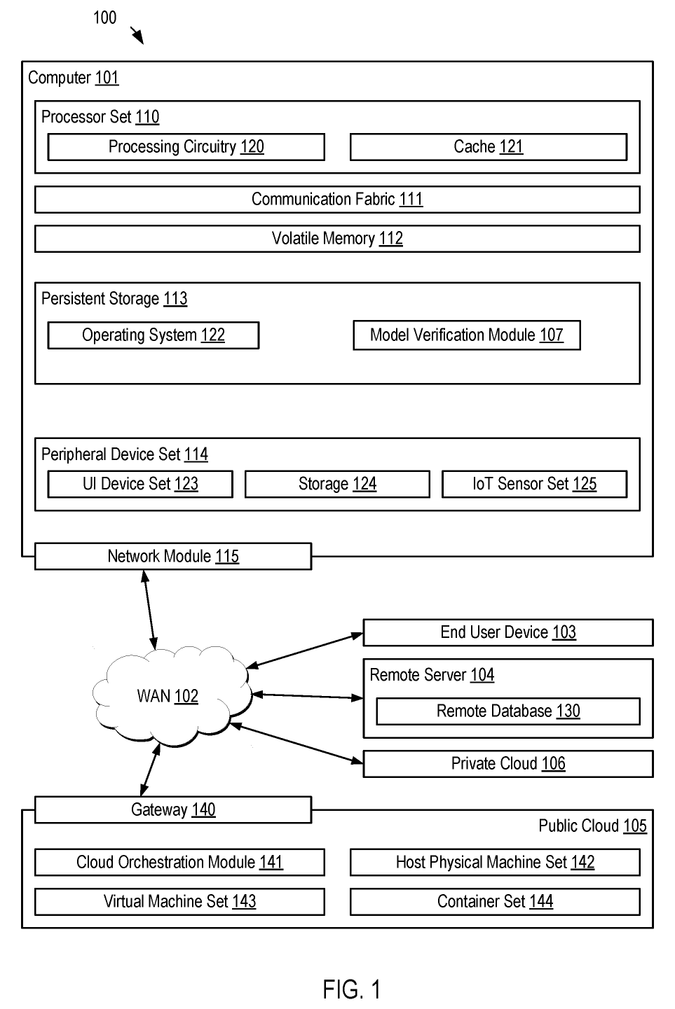

With reference now to FIG. 1, shown is FIG. 1 sets forth an example computing environment according to aspects of the present disclosure. Computing environment 100 contains an example of an environment for the execution of at least some of the computer code involved in performing the various methods described herein, such as the model verification module 107. In addition to model verification module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model verification module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in model verification module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in model verification module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

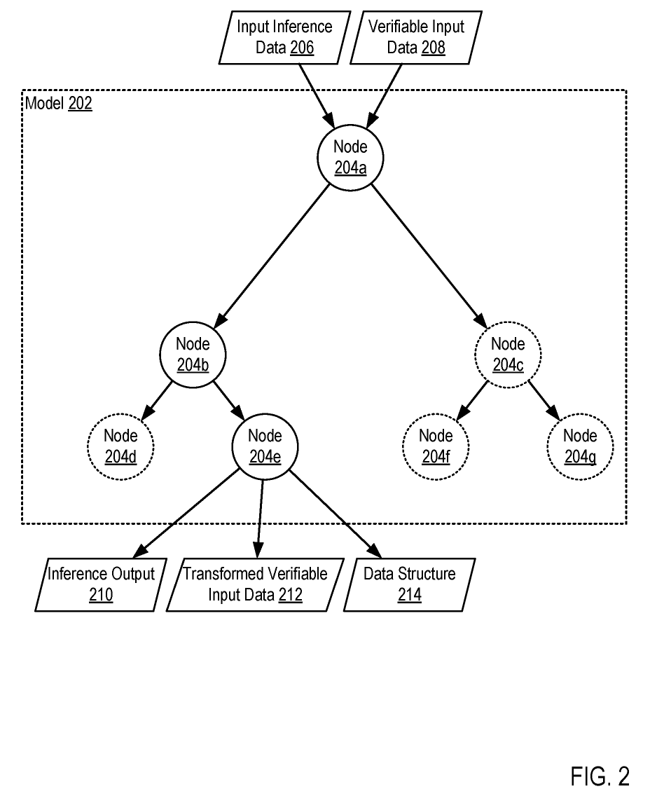

FIG. 2 sets forth a diagram of parallel inference and model verification for secure verification of trained models in accordance with some embodiments of the present disclosure. FIG. 2 includes a model 202. The model 202 may include any type of trained machine learning model as can be appreciated, such as a neural network, a decision tree, or another trained model as can be appreciated. The model 202 includes a plurality of nodes 204a,b,c,d,e,f,g. Each node 204a-g may include a logical subcomponent of the model 202 that applies some functions or transformations to its input as part of an inference operation. As described herein, an inference operation is any operation performed using a trained model whereby some output is generated based on some supplied input data. As an example, where the model 202 includes a decision tree, each node 204a-g may include a node 204a-g of the decision tree whereby some decision is made. As another example, where the model 202 includes a neural network, each mode 204a-g may include a neuron. Each node 204a-g may accept some portion of input from potentially many other nodes 204a-g and may provide some portion of output to potentially many other nodes 204a-g.

The model 202 accepts, as input, input inference data 206 and verifiable input data 208. Although not shown, additional metadata may also be used as input. The input inference data 206 may include any type of input data from which an inference may be generated using the model 202. The particular type of input inference data 206 may vary depending on the particular domain(s) for which the model 202 is trained to perform inferences. The verifiable input data 208 is data to which transformations are applied in parallel with the inference operation, to be described in further detail below, by tracing the inference path of the model 202 during the inference operation.

The inference path of the model 202 for an inference operation describes a particular path of data through the model 202 during the inference operation. For example, where the model 202 is a decision tree, the inference path may include a particular path of nodes 204a-g traversed through the decision tree as part of the inference operation. As another example, where the model 202 is a neural network, the inference path may include an activation path of neurons across multiple layers of the neural network. Here, nodes 204a,b,e included in the inference path are shown with a solid outline while nodes 204c,d,f,g not included in the inference path are shown with dotted outlines.

To perform the inference operation, each node 204a-g (e.g., each node 204a,b,e of the activation path) accepts some input and produces some output. This input may include the input inference data 206 or the output from some higher-level node 204a-g. This output may include some output that serves as input to another node 204a-g or the inference output 210 (e.g., the result or output of the inference operation). To produce its output, each node 204a-g applies some inference-related function(s) to its input which may include comparison operations, sigmoid functions, activation functions, and the like. In other words, each node 204a-g may apply one or more inference functions to inference node input to produce an inference node output.

As is set forth above, the verifiable input data 208 is some input data to which one or more transformations may be applied, and later reversed, so as to verify the model 202. For example, the verifiable input data 208 may include a string, a tensor, a hash value, or some other data as can be appreciated. To apply the transformations to the verifiable input data 208, one or more transformations are applied at each node 204a-g of the inference path. Here, transformations are applied at each node 204a,b,e to generate the transformed verifiable input data 212. Accordingly, each node 204a-g may apply a transformation function to some input (e.g., the verifiable input data 208 or some transformed version received from another node 204a-g) to produce some output (e.g., either the final transformed verifiable input data 212 or data to be used as input by another node 204a-g). In other words, at each node 204a-g, one or more transformations may be applied to transformation input to produce transformation output. The transformation function may apply, as one or more transformations, one or more logical operations to the input. In some embodiments, the transformation function may also accept additional parameters such as the node 204a-g for which the transformations are applied, an identifier or owner of the model, or other parameters as can be appreciated. Such parameters may be derived, for example, from additional metadata provided as input to the model, or from other sources.

In some embodiments, the one or more logical operations may include hardware-level logical operations. In some embodiments, the one or more logical operations may be implemented at the software level using hardware simulation code. In some embodiments, the particular implementation of the transformation public will not be publicly available so as to prevent workarounds or reverse-engineering the transformation function, thereby increasing overall security for the verification function.

In some embodiments, performing the inference operation and applying the transformations may be performed in parallel and in a synchronized manner. The inference operation and the transformations are performed in parallel in that they are performed, for a particular node 204a-g, substantially simultaneously and concurrently. The inference operation and the transformations are performed in a synchronized manner in that the inference functions and transformations for a given node 204a-g must both be completed before processing by the next downstream node 204a-g. Here, for example, inference functions and transformations must be completed by the node 204a as applied to the input inference data 206 and verifiable input data 208 before the node 204b can begin processing any inputs from the node 204a. The inference functions and transformations to be performed by the node 204b must both be completed before the respective outputs are provided to the node 204e. The inference functions and transformations to be performed by the node 204e must both be completed before the respective outputs are provided as the inference output 210 and transformed verifiable input data 212. In some embodiments, where the model 202 includes a neural network of multiple layers of nodes 204a-g, the nodes 204a-g of a given layer must complete its inference operations and transformations before the next layer of nodes 204a-g may begin processing.

To facilitate these parallel inference and transformation functions, in some embodiments, the inference operations may be performed using an accelerator such as an artificial intelligence unit (AIU), specialized hardware designed for machine learning tasks such as model training and inference. In some embodiments, the one or more transformations may be applied using a trusted hardware unit (THU), a trusted execution environment or secure enclave with dedicated compute resources specifically designed for performing logical operations on verifiable input data 208 or transformed variations thereof. In some embodiments, the THU may be implemented using physical hardware or simulated in software. In some embodiments, the AIU may house a physical component that acts as a THU, or they may be physically decoupled. As the transformations are applied using the THU, the transformations may be applied in a known and predictable manner so that these transformations can be later reversed as part of the verification operation. Thus, if this verification fails, this may indicate that the model 202 is not executed in the particular computing environment including the THU in which it was supposed to be executed.

In some embodiments, a data structure 214 storing data describing the inference path and the corresponding inference functions and transformations applied may be generated. For example, this data structure 214 may indicate, for an edge between a first and second node 204a-g, the inference node inputs from the first to the second node 204a-g, transformation inputs from the first to the second node 204a-g, inference node outputs from the second node 204a-g, and transformation outputs from the second node 204a-g. In some embodiments, this data structure 214 may include metadata describing the particular inference functions and/or transformations applied for each node 204a-g. This metadata may include, for example, a number of operations applied, hardware identifiers such as a media access control (MAC) address at each operation (e.g., on the AIU and/or THU), tensor checksums, or other identifiable attributes. In some embodiments, this metadata may include a geographic location of the model (or models, if an ensemble), a geographic location of the model invoker, and the like.

The model 202 may then be verified by reversing the transformations applied to the verifiable input data 208 to generate the transformed verifiable input data 212. For example, the transformation function applied at each node204a-g may have a corresponding inverse function that undoes or rolls back any changes applied. For example, for a transformation function t(X)=X’ and a reverse transformation function t’(X’) = X, t’(t(X)) = X. Accordingly, reversing each transformation applied to produce the transformed verifiable input data 212 should produce the verifiable input data 208 or similar data. For example, in some embodiments, reversing the transformations applied to the transformed verifiable input data 212 may generate an expected value for the verifiable input data 208.

This expected value may then be compared to an actual value of the verifiable input data 208. In some embodiments, the model 202 may pass verification where the expected and actual values are equal. In some embodiments, the model 202 may pass verification where the expected and actual values have a degree of similarity exceeding some threshold. Readers will appreciate that the particular approaches for verifying the model 202 may depend on the particular implementations for the transformers or other aspects of the model 202. Assuming that the model 202 to perform the inference operation is the expected model and the execution environment for the model 202 is as expected or promised, model 202 verification should pass. In some embodiments the metadata included in the data structure 214 may facilitate verification due to one or more values stored therein being used as parameters of a reverse transformation function. In some embodiments, the metadata included in the data structure 214 may also be audited to determine if the particular hardware and execution environment for the model 202 matches the expected or promised hardware and execution environment.

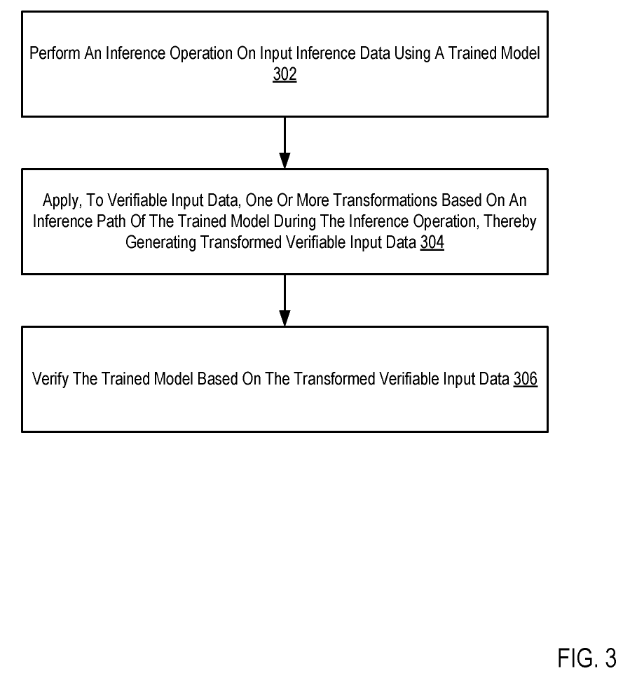

For further explanation, FIG. 3 sets forth a flowchart of an example method of secure verification of trained models in accordance with some embodiments of the present disclosure. The method of FIG. 3 may be performed, for example, by the model verification module 107 of FIG. 1. The method of FIG. 3 includes performing 302 an inference operation on input inference data 206 using a trained model 202. The trained model 202 may include any type of trained machine learning model 202, such as a decision tree, a neural network, and the like. The trained model 202 may be composed of multiple intercommunicating nodes 204a-g that each accept some inference node input to produce inference node output. For example, each node 204a-g may accept some portion of the input inference data 206 or the inference node output from another node 204a-g. To generate its inference node output, each node 204a-g may apply inference functions to its inference node input. The particular domain of the input inference data 206 and the resulting inference output 210 may vary depending on the particular implementation of the mode 202 and various design and engineering considerations.

The method of FIG. 3 also includes applying 304, to verifiable input data 208, one or more transformations based on an inference path of the trained model 202 during the inference operation, thereby generating transformed verifiable input data 212. The inference path of the trained model 202 describes the particular nodes 204a-g used in generating the inference output 210. For example, where the model 202 includes a decision tree, the inference path may include a path of nodes 204a-g traversed using the decision tree. As another example, where the model 202 includes a neural network, the inference path may include an activation path of the model 202 (e.g., the particular neuron nodes 204a-g activated as part of the inference operation).

Each node 204a-g may also accept transformation input and produce transformation output by applying a transformation function to the transformation input. Accordingly, to generate the transformed verifiable input data 212, transformation functions are applied for each node 204a-g on the activation path. Thus, the flow of the input inference data 206 and its associated inference functions matches the flow of verifiable input data 208 and its associated transformations. The one or more transformations applied at each node 204a-g may include, for example, logical operations. The transformation function may accept multiple parameters in addition to the transformation input, such as the node 204a-g for which the transformations are applied, an identifier or owner of the model, or other parameters as can be appreciated. The particular implementation of the transformation function may be hidden to prevent workarounds or reverse engineering.

The method of FIG. 3 also includes verifying 306 the trained model 202 based on the transformed verifiable input data 212. Assuming the model 202 is the expected model and assuming that the model 202 is executed in the promised or expected environment, the transformations should be applied in a predictable and/or reversible fashion so that the transformed verifiable input data 212 may be used to verify the model. Accordingly, in some embodiments, as will be described in further detail below, the trained model 202 may be verified by comparing an expected value for the verifiable input data 208, calculated by reversing the transformations applied to generate the verifiable input data 212, to the actual value of the verifiable input data 208 as input to the model.

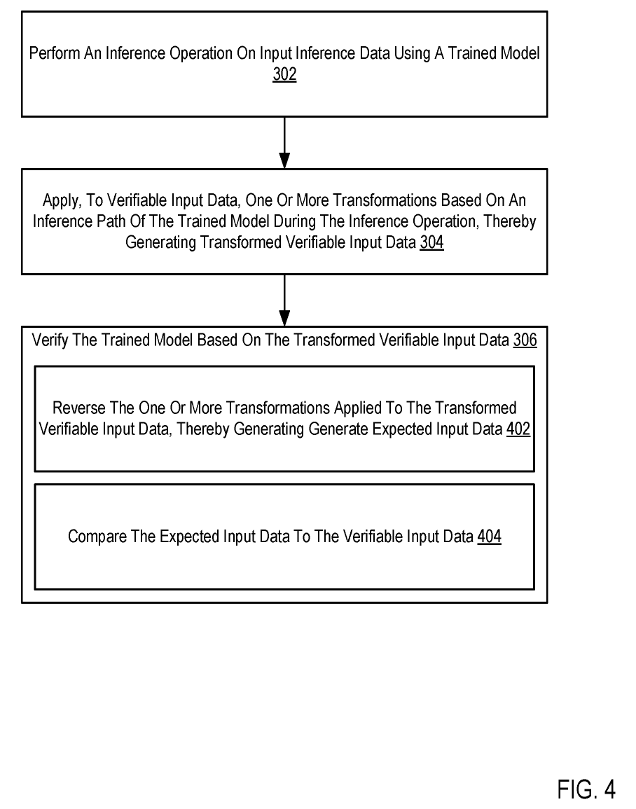

For further explanation, FIG. 4 sets forth a flowchart of another example method of secure verification of trained models in accordance with some embodiments of the present disclosure. The method of FIG. 4 is similar to FIG. 3 in that the method of FIG. 4 also includes: performing 302 an inference operation on input inference data 206 using a trained model 202; applying 304, to verifiable input data 208, one or more transformations based on an inference path of the trained model 202 during the inference operation, thereby generating transformed verifiable input data 212; and verifying 306 the trained model 202 based on the transformed verifiable input data 212.

The method of FIG. 4 differs from FIG. 3 in that verifying 306 the trained model 202 based on the transformed verifiable input data 212 also includes reversing 402 the one or more transformations applied to the transformed verifiable input data, thereby generating expected input data. The expected input data includes an expected value for the verifiable input data 208 generated by reversing the transformations applied to generate the transformed verifiable input data 212. For example, the transformations applied for a given node 204a-g may be reversed by applying a reverse transformation function to the transformation output produced by the given node 204a-g. Applying this reverse transformation function should produce the transformation input provided to the given node 204a-g. Thus, by repeatedly applying reverse transformation functions by reversing the inference path of the inference operation, the verifiable input data 208 or a substantially similar value should be produced.

The method of FIG. 4 further differs from FIG. 3 in that verifying 306 the trained model 202 based on the transformed verifiable input data 212 also includes comparing 404 the expected input data to the verifiable input data 208. In some embodiments, the model 202 may pass verification where the expected input data equals the verifiable input data 208. In some embodiments, the model 202 may pass verification where the expected input data is substantially similar to verifiable input data 208. For example, in some embodiments, the model 202 may pass verification where the expected input data has a degree of similarity relative to the verifiable input data 208 exceeding some threshold. The particular approaches for comparison may depend on the particular implementation of the model 202 and/or the transformation functions, including the implementation of transformers of the model 202.

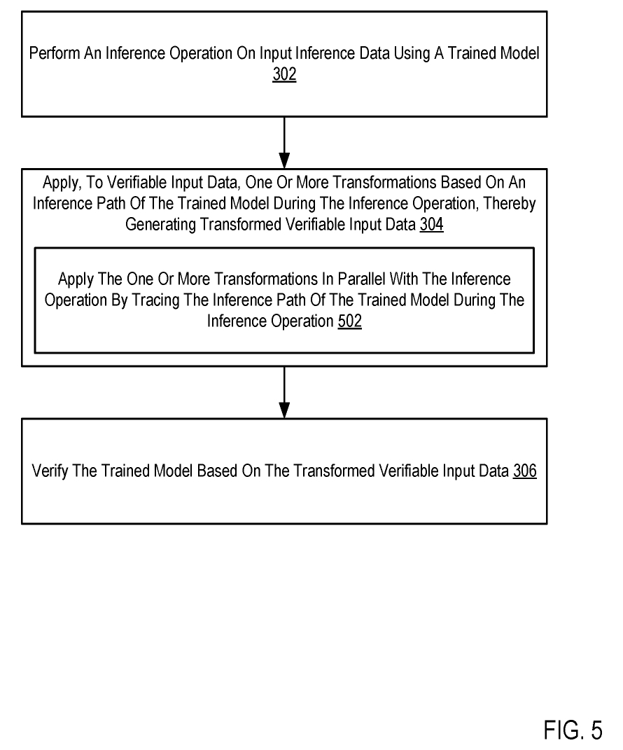

For further explanation, FIG. 5 sets forth a flowchart of another example method of secure verification of trained models in accordance with some embodiments of the present disclosure. The method of FIG. 5 is similar to FIG. 3 in that the method of FIG. 5 also includes: performing 302 an inference operation on input inference data 206 using a trained model 202; applying 304, to verifiable input data 208, one or more transformations based on an inference path of the trained model 202 during the inference operation, thereby generating transformed verifiable input data 212; and verifying 306 the trained model 202 based on the transformed verifiable input data 212.

The method of FIG. 5 differs from FIG. 3 in that applying 304, to verifiable input data 208, one or more transformations based on an inference path of the trained model 202 during the inference operation, thereby generating transformed verifiable input data 212 also includes applying 502 the one or more transformations in parallel with the inference operation by tracing the inference path of the trained model 202 during the inference operation. In some embodiments, the inference operation and the transformations may be performed in parallel and in a synchronized manner. The inference operation and the transformations are performed in parallel in that they are performed, for a particular node 204a-g, substantially simultaneously and concurrently. The inference operation and the transformations are performed in a synchronized manner in that the inference functions and transformations for a given node 204a-g must both be completed before processing by the next downstream node 204a-g. Here, for example, inference functions and transformations must be completed by the node 204a as applied to the input inference data 206 and verifiable input data 208 before the node 204b can begin processing any inputs from the node 204a. The inference functions and transformations to be performed by the node 204b must both be completed before the respective outputs are provided to the node 204e. The inference functions and transformations to be performed by the node 204e must both be completed before the respective outputs are provided as the inference output 210 and transformed verifiable input data 212.

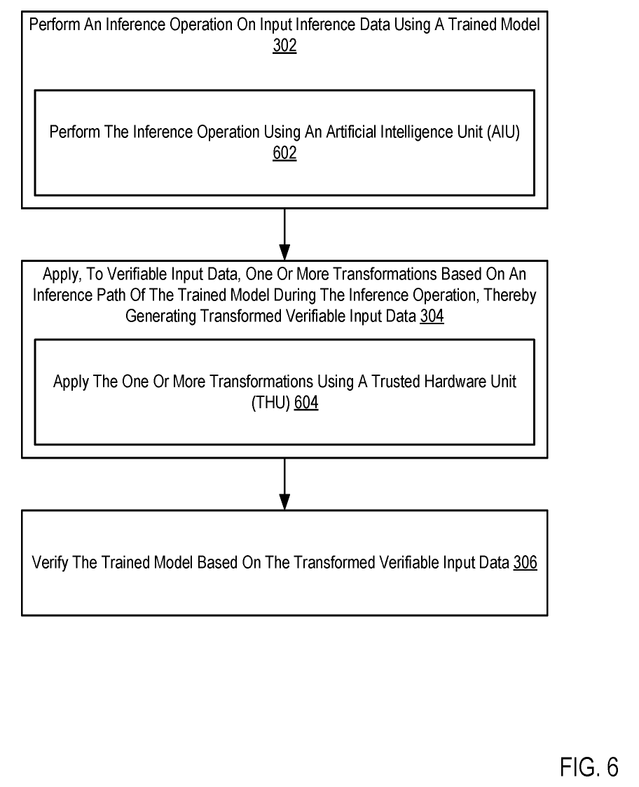

For further explanation, FIG. 6 sets forth a flowchart of another example method of secure verification of trained models in accordance with some embodiments of the present disclosure. The method of FIG. 6 is similar to FIG. 3 in that the method of FIG. 6 also includes: performing 302 an inference operation on input inference data 206 using a trained model 202; applying 304, to verifiable input data 208, one or more transformations based on an inference path of the trained model 202 during the inference operation, thereby generating transformed verifiable input data 212; and verifying 306 the trained model 202 based on the transformed verifiable input data 212.

The method of FIG. 6 differs from FIG. 3 in that performing 302 an inference operation on input inference data 206 using a trained model 202 also includes performing 602 the inference operation using an artificial intelligence unit (AIU); and applying 304, to verifiable input data 208, one or more transformations based on an inference path of the trained model 202 during the inference operation, thereby generating transformed verifiable input data 212 also includes applying 604 the one or more transformations using a trusted hardware unit (THU). For example, in some embodiments, to facilitate parallel inference and transformation functions, the inference operations may be performed using an accelerator such as an artificial intelligence unit (AIU), specialized hardware designed for machine learning tasks such as model training and inference. Readers will appreciate that the use of an AIU is merely exemplary and that other hardware-based accelerators may also be used for performing 602 the inference operation.

In some embodiments, the one or more transformations may be applied using a trusted hardware unit (THU), a trusted execution environment or secure enclave with dedicated compute resources specifically designed for performing logical operations on verifiable input data 208 or transformed variations thereof. In some embodiments, the THU may be implemented using physical hardware or simulated in software. In some embodiments, the AIU may house a physical component that acts as a THU, or they may be physically decoupled. As the transformations are applied using the THU, the transformations may be applied in a known and predictable manner so that these transformations can be later reversed as part of the verification operation. Thus, if this verification fails, this may indicate that the model 202 is not executed in the particular computing environment including the THU in which it was supposed to be executed.

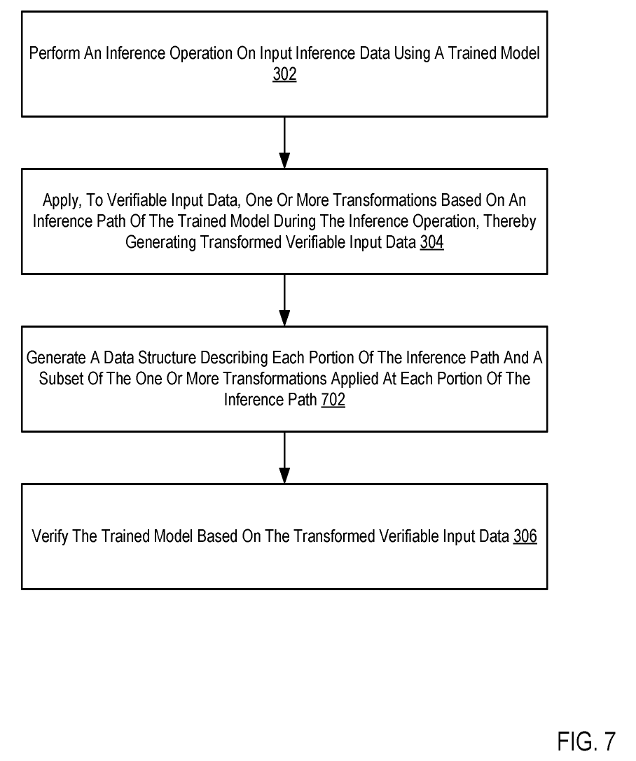

For further explanation, FIG. 7 sets forth a flowchart of another example method of secure verification of trained models in accordance with some embodiments of the present disclosure. The method of FIG. 7 is similar to FIG. 3 in that the method of FIG. 7 also includes: performing 302 an inference operation on input inference data 206 using a trained model 202; applying 304, to verifiable input data 208, one or more transformations based on an inference path of the trained model 202 during the inference operation, thereby generating transformed verifiable input data 212; and verifying 306 the trained model 202 based on the transformed verifiable input data 212.

The method of FIG. 7 differs from FIG. 3 in that the method of FIG. 7 also includes: generating 702 a data structure 214 describing each portion of the inference path and a subset of the one or more transformations applied at each portion of the inference path. For example, in some embodiments, this data structure 214 may indicate, for an edge between a first and second node 204a-g, the inference node inputs from the first to the second node 204a-g, transformation inputs from the first to the second node 204a-g, inference node outputs from the second node 204a-g, and transformation outputs from the second node 204a-g. In some embodiments, this data structure 214 may include metadata describing the particular inference functions and/or transformations applied for each node 204a-g. This metadata may include, for example, a number of operations applied, hardware identifiers such as a media access control (MAC) address at each operation (e.g., on the AIU and/or THU), tensor checksums, or other identifiable attributes. In some embodiments, this metadata may include a geographic location of the model (or models, if an ensemble), a geographic location of the model invoker, and the like. This data structure 214 and the encoded metadata may be used for various purposes, including auditing individual steps through the inference path, for parameters in reversing transformation functions, and the like.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing an inference operation on input inference data using a trained model;
applying, to verifiable input data, one or more transformations based on an inference path of the trained model during the inference operation, thereby generating transformed verifiable input data; and
verifying the trained model based on the transformed verifiable input data.

2. The method of claim 1, wherein verifying the trained model based on the transformed verifiable input data comprises:
reversing the one or more transformations applied to the transformed verifiable input data thereby generating expected input data; and
comparing the expected input data to the verifiable input data.

3. The method of claim 1, wherein applying the one or more transformations comprises applying the one or more transformations in parallel with the inference operation by tracing the inference path of the trained model during the inference operation.

4. The method of claim 1, wherein performing the inference operation comprises performing the inference operation using an artificial intelligence unit (AIU).

5. The method of claim 1, wherein applying the one or more transformations comprises applying the one or more transformations using a trusted hardware unit (THU).

6. The method of claim 1, further comprising generating a data structure describing each portion of the inference path and a subset of the one or more transformations applied at each portion of the inference path.

7. The method of claim 1, wherein the one or more transformations comprise one or more logical operations.

8. A computer system comprising:
a processor set;
one or more computer-readable storage media; and
program instructions stored on the one or more storage media to cause the processor set to perform operations comprising:
performing an inference operation on input inference data using a trained model;
applying, to verifiable input data, one or more transformations based on an inference path of the trained model during the inference operation, thereby generating transformed verifiable input data; and
verifying the trained model based on the transformed verifiable input data.

9. The computer system of claim 8, wherein verifying the trained model based on the transformed verifiable input data comprises:
reversing the one or more transformations applied to the transformed verifiable input data thereby generating expected input data; and
comparing the expected input data to the verifiable input data.

10. The computer system of claim 8, wherein applying the one or more transformations comprises applying the one or more transformations in parallel with the inference operation by tracing the inference path of the trained model during the inference operation.

11. The computer system of claim 8, wherein performing the inference operation comprises performing the inference operation using an artificial intelligence unit (AIU).

12. The computer system of claim 8, wherein applying the one or more transformations comprises applying the one or more transformations using a trusted hardware unit (THU).

13. The computer system of claim 8, wherein the operations further comprise generating a data structure describing each portion of the inference path and a subset of the one or more transformations applied at each portion of the inference path.

14. The computer system of claim 8, wherein the one or more transformations comprise one or more logical operations.

15. A computer program product comprising:
one or more computer-readable storage media; and
program instructions stored on the one or more storage media to perform operations comprising:
performing an inference operation on input inference data using a trained model;
applying, to verifiable input data, one or more transformations based on an inference path of the trained model during the inference operation, thereby generating transformed verifiable input data; and
verifying the trained model based on the transformed verifiable input data.

16. The computer program product of claim 15, wherein verifying the trained model based on the transformed verifiable input data comprises:
reversing the one or more transformations applied to the transformed verifiable input data thereby generating expected input data; and
comparing the expected input data to the verifiable input data.

17. The computer program product of claim 15, wherein applying the one or more transformations comprises applying the one or more transformations in parallel with the inference operation by tracing the inference path of the trained model during the inference operation.

18. The computer program product of claim 15, wherein performing the inference operation comprises performing the inference operation using an artificial intelligence unit (AIU).

19. The computer program product of claim 15, wherein applying the one or more transformations comprises applying the one or more transformations using a trusted hardware unit (THU).

20. The computer program product of claim 15, wherein the operations further comprise generating a data structure describing each portion of the inference path and a subset of the one or more transformations applied at each portion of the inference path.
